(19) United States
(12) Patent Application Publication
(10) Pub. No.: US 2005/0196492 A1
(43) Pub. Date: Sep. 8, 2005

(54) Food preservative method and system using vanillin and constituent having isothiocynate compound

(76) Inventors: Wayne S. Muller, Hopkinton, MA (US); Anthony Sikes, Fiskdale, MA (US)

Correspondence Address: U.S. Army Soldier Systems Center, Kansas Street, Natick, MA, 01760, US

(21) Appl. No.: 10/795,145

(22) Filed: Mar. 4, 2004

(51) Int. Cl. A23B 4/00

(52) U.S. Cl. 426/112

(57) ABSTRACT

The present invention is directed to a technique for preserving foods. In one embodiment, the invention is directed to a product comprising a compound comprising vanillin, and an organic constituent comprising an isothiocynate compound. In another embodiment, the present invention is directed to a method of preserving a food product comprising incorporating a compound comprising vanillin into the food product, and exposing the food product to an organic constituent having an isothiocynate compound. In a further embodiment, the present invention is directed to a preserved packaged food product, comprising a package having a package interior and a package interior surface, a food product positioned in the package interior and having a compound comprising vanillin, and an organic constituent comprising an isothiocynate compound disposed on the package interior surface so as to contact the food product.

### STATEMENT OF GOVERNMENT INTEREST

The invention described herein may be manufactured and used by the U.S. Government for Governmental purposes without the payment of any royalties thereon.

### BACKGROUND OF THE INVENTION

1. Field of the Invention

The present invention generally relates to food preservatives.

2. Description of the Related Art

Consumer products can provide a hospitable environment for rapid microbial growth. Such exposure can, and frequently does, result from inadvertent microbial inoculation of the product during manufacturing or packaging. Spoilage microorganisms, for example in food or beverage products, can then rapidly proliferate by feeding on nutrients provided by the product. Preservatives, such as sorbates, benzoates, organic acids, and combinations thereof have been used in various products, particularly foods and beverages, to provide some degree of microbial growth inhibition. At levels effective to inhibit microbial growth, some of these preservatives can contribute off-flavors in the product, thereby making the product undesirable for its intended purpose.

In the development of military food, it is necessary to take into consideration unique requirements that typically, are not relevant in the commercial sector. For example, MRE (meal-ready-to-eat) military bread requires a minimum storage period of three years at 80° F. Military bread and baked goods are typically formulated with some type of hurdle technology so as to prevent the growth of bacteria, such as a low water activity (<0.89) and pH (5-6). In addition, the foregoing bread or baked goods are specially formulated to prevent spoilage and then sealed in an impermeable package with an oxygen scavenger. These bread or baked goods usually require another preservative to protect the product initially before the oxygen scavenger is fully functional. For example, in military MRE breads, potassium sorbate is required in the bread formulation to prevent outgrowth of fungi during the first few days after packaging. Furthermore, even with these demanding requirements, there has been an increased emphasis in the military, as well as the commercial sector, on the use of natural preservatives.

The prior art reveals several different food preservative systems, compounds and techniques. U.S. Pat. No. 5,002,790 discloses the use of vanillin to protect dry food against oxidation. Specifically, this patent discloses the use of vanillin in a quantity of 5 to 5000 μg vanillin per gram of food dry matter. U.S. Pat. No. 5,989,612 discloses the use of vanillin (e.g. methyl vanillin or ethyl vanillin) as an antimycotic in food products. The '612 patent also describes the use of essential oils as a potentiator. U.S. Pat. Nos. 6,361,812 and 6,558,723 and Published Application Nos. 2002/0061352 and 2003/0211209 disclose a preservative system that has a constituent comprising one or more isothiocynate compounds, and a preservative selected from sorbate and/or benzoate preservatives, and mixtures thereof. U.S. Pat. No. 5,880,150 discloses the use of allyl isothiocynate compound as a vapor to treat the outside of porous food packaging. U.S. Pat. No. 5,334,373 discloses the use of allyl mustard oil for the purpose of bacteriostatic or germicidal treatment. Specifically, the '373 patent discloses an allyl isothiocyanate spray that is suitable for bacteriorstatic or germicidal treatment or for quality preservation. U.S. Pat. No. 3,998,964 discloses a therapeutic composition that utilizes mustard oils for the purpose of providing antibacterial and antimycotic effects of mustard oils for therapeutic compositions.

What is needed is a new and improved food preservative that provides microbial inhibition without the production of off-flavors and which can be used in both military and commercial applications. Another desirable feature of such a food preservative system is that it be relatively inexpensive to implement.

### SUMMARY OF THE INVENTION

The present invention relates to products providing an antimicrobial effect as well as methods of their use. The present inventors have surprisingly discovered that a constituent comprising one or more isothiocyanate compounds in combination with vanillin exhibits a strong antimicrobial effect without imparting off-flavors or offensive odors in the final product. In doing so, the present inventors have discovered a synergistic relationship between the relative effects of each of these preservative components when utilized in combination. Surprisingly, when utilized in combination, each of the preservative components is effective at levels low enough to maintain the integrity of the final food product.

It has been found that a combination of natural food antimicrobial agents such as vanillin and a constituent having an isothiocyanate compound results in an excellent antimicrobial food preservative. In a preferred embodiment, the organic constituent is selected from the group consisting of a Cruciferae essential oil and a natural component of a Cruciferae essential oil.

Thus, in one aspect, the present invention is directed to a product comprising a compound comprising vanillin, and an organic constituent comprising an isothiocynate compound. In a preferred embodiment, the constituent is selected from the group consisting of a Cruciferae essential oil and a natural component of a Cruciferae essential oil. In a most preferred embodiment, the Cruciferae essential oil is derived from a plant selected from the group consisting of cabbage, broccoli, Brussels sprout, turnip, mustard, watercress, radish, wasabi, and horseradish. Preferably, the plant is mustard. The isothiocynate compound comprises allyl isothiocynate and the vanillin is comprised of 4-hydroxy-3-methylbenzaldehyde.

In a related aspect, the present invention comprises a first antimicrobial agent comprising vanillin, and a second antimicrobial agent comprising volatile oil of mustard.

In a further aspect, the present invention is directed to a method of preserving a food product comprising incorporating a compound comprising vanillin into the food product, and exposing the food product to an organic constituent having an isothiocynate compound. In a preferred embodiment, the constituent is volatile mustard of oil.

In another aspect, the present invention is directed to a preserved packaged food product, comprising a package having a package interior sized for receiving a food product and a package interior surface, a food product positioned in the package interior and having a compound comprising vanillin, and an organic constituent comprising an isothiocynate compound disposed on the package interior surface so as to contact the food product. In a preferred embodiment, the organic constituent is volatile mustard of oil.

As a result of using the combination of vanillin and volatile mustard of oil in accordance with the invention, it is possible to eliminate the need for the oxygen scavengers and any preservative, such as potassium sorbate, usually used in conjunction with the oxygen scavenger. In accordance with the invention, the vanillin is incorporated into the food product at relatively low concentrations to provide antimicrobial protection in the product, and the volatile mustard of oil is incorporated into the product packaging material as a volatile agent to protect the headspace of the package and the surface area of the product. Preferably, the product package comprises impermeable material to prevent the escape of any volatile mustard of oil. The vanillin provides a pleasant taste and odor to the product and packaging material thereby masking any off-odors or flavors created by the pungent odor of the volatile mustard of oil.

In accordance with the invention, the food product of interest (e.g. bread) is formulated with the appropriate concentration of vanillin. In a preferred embodiment, the packaging material is impermeable to air thereby sealing the volatile oil of mustard into the headspace of the package once the package is sealed. In one embodiment, the volatile oil of mustard is incorporated into the product package by using an adhesive label having a known quantity of volatile oil of mustard thereon. The concentration of vanillin depends on the particular product and the particular concentration of volatile mustard of oil. For example, it has been found that in order to effectively control the outgrowth of fungal spores in MRE (Meal-Ready-To-Eat) bread having a vanillin concentration of 1200-1500 ppm, a volatile oil of mustard concentration in the package headspace of 50-100 ppm is required.

The combination of the vanillin and volatile oil of mustard is fungicidal and prevents the spoilage of the product as long as the integrity of package material is maintained. A synergistic effect was observed when both the vanillin and volatile oil of mustard were used in MRE packages containing two different fungi.

The preservative of the present invention can be applied to any military or commercial product that may have a problem with the potential outgrowth of fungi or yeast spores over time.

### BRIEF DESCRIPTION OF THE DRAWING

FIG. 1 is cross-sectional diagram of a packaged preserved food product in accordance with one embodiment of the invention.

### DESCRIPTION OF THE PREFERRED EMBODIMENTS

In the description of the invention various embodiments and/or individual features are disclosed. As will be apparent to the ordinarily skilled practitioner, all combinations of such embodiments and features are possible and can result in preferred executions of the invention.

The products herein may comprise, consist essentially of, or consist of any of the elements as described herein.

Although the ensuing discussion pertains to military food applications, such as a military MRE (Meal-Ready-To-Eat), it is to be understood that the present invention may be used in non-military or civilian food products as well.

The food products contemplated within the present invention include, for example, baked good mixes (e.g., breads, cakes, brownies, muffins, cookies, pastries, pies, crackers, pie crusts), fried snacks derived from potatoes, corn, wheat and other grains (e.g., potato chips, corn chips, tortilla chips), other fried farinaceous snack foods (e.g., French fries, doughnuts, fried chicken), dairy products, (e.g., butter, ice cream and other fat-containing frozen desserts, yogurt, and cheeses, including natural cheeses, processed cheeses, cream cheese, cottage cheese, cheese foods, cheese spread, milk, cream, sour cream, butter milk, and creamers), cereal products, baby foods or formulas, puddings, ice cream, dips, syrups, pie and other dessert fillings, frostings, emulsified spreads, salad dressings, mayonnaise, margarine, processed meat products such as sausages, hot dogs, and uncooked fermented manufactured meat products.

1. Definition and Usage of Terms

The following is a list of definitions for terms used herein:

As used herein, the abbreviations “PPM” or “ppm” represent “parts per million” as is commonly known in the art.

As used herein, the abbreviation “VOM” refers to “volatile of oil mustard”.

As used herein, the abbreviation “AIT” refers to “allyl isothiocyanate”.

As used herein, Wasaouro® is a registered trademark of CAREX, Inc. and Wasaouro® Label refers to an adhesive label manufactured and marketed by CAREX, Inc. which contains VOM thereon.

As used herein, “essential oil” refers to the set of all the compounds that can be distilled from the plant from which the oil is derived and that contributes to the characteristic aroma of that plant. In accordance with the present invention, the essential oil preferably originates from a glucosinolate compound which is capable of producing an isothiocyanate compound (for example, through the catalytic hydrolysis of one or more glucosinolates by the enzyme myrosinase) wherein the precursor and enzyme containing plant tissue is homogenized, ground, crushed, pressed, or otherwise damaged.

As used herein, the term “antimicrobial effect” means that the product inhibits growth or, eliminates, and/or otherwise decreases the presence of microbials, such as, for example, yeast bacteria, mold, and/or fungus.

As used herein, “effective amount” of constituent, compound, composition, preservative, or the like means an amount that is effective to exhibit antimicrobial activity, preferably wherein the antimicrobial activity is inhibiting growth of, eliminating, and/or otherwise decreasing the presence of microbials such as, for example, yeast, bacteria, mold, and fungus, preferably yeast and molds. Non-limiting examples of such yeast include Candida tropicalis, Candida albicans, Hansenula anomala, Saccharomyces cerevisiae, Torulaspora delbreuckii, Zygosaccharomyces bailii, and Zygosaccharomyces rouxii. Non-limiting examples of such bacteria including Bacillus subtilis, Bacillus cereus, Staphylococcus aureus, Staphylococus epidermidis, Escherichia coli, Salmonella typhimurium, Salmonella enteritidis, Vibrio parahaemolyticus, and Pseudomonas aeruginosa. Non-limiting examples of such mold include Aspergillus niger, Aspergillus flavus, Penicillium islandicum, Penicillium citrinum, Penicillium chrysogenum, Fusarium oxysporum, Fusarium graminearum, Fusarium solani, Alternaria alternata, and Mucor racemosus.

As used herein, the term “volatile” means that the respective isothiocyanate is capable of steam distillation at ambient pressure.

It has been found that a combination of natural food antimicrobial agents such as vanillin and volatile oil of mustard results in an excellent antimicrobial food preservative. There are two sources of vanillin (4-hydroxy-3-methylbenzaldehyde). Natural vanillin is a major constituent of vanilla beans. Vanillin (USP) can also be produced from biodegradation of lignin, a paper manufacturing byproduct. The vanillin from both of these sources has the same chemical structure and exhibits antimicrobial activity.

Volatile oil of mustard (“VOM”) is a natural antimicrobial product in which the active antimicrobial compound is allyl isothiocyanate (“AIT”). As an antimicrobial agent, VOM is most effective in the volatile vapor state, whereas vanillin is only effective as an antimicrobial when in contact with the microorganism. Volatile oil of mustard is derived from mustard seed extract which has a very pungent smell resembling that of horseradish. Vanillin, on the other hand, has a very pleasant smell, very much like vanilla. It has been found that the combination of vanillin and volatile oil of mustard masks any unpleasant odors and provides an excellent antimicrobial combination to inhibit food spoilage organisms.

In a preferred embodiment, the constituent comprising the isothiocyanate compound is an essential oil, or natural component of an essential oil, of any of the Cruciferae family of plants. Alternatively, the constituent comprising the isothiocyanate compound may also be an essential oil, or natural component of an essential oil, of any other family of plants which may produce an isothiocyanate compound (through, for example, reaction of myrosinase with a glucosinolate compound; by natural introduction of myrosinase) including, for example, the Resedaceae and Capparidaceae families of plants and, as other non-limiting examples, garlic and onion. Thus, although VOM has been described as a preferred source of a naturally derived allyl isothiocyanate compound, it is to be understood that other natural sources comprising isothiocyanate compounds may be used, e.g. horseradish, turnip, cabbage, brussels sprout, kale, collards, cauliflower, watercress and rapeseed. Other natural sources comprising isothiocyanate compounds are described in U.S. Pat. No. 6,558,723, the disclosure of which patent is incorporated herein by reference.

Four bread spoilage organisms were used in determining the inhibition properties of vanillin and VOM: (1) Penicillium notatum, (2) Rhizopus stolonifer, (3) Aspergillus niger and (4) Saccharomycopsis fibuligera. For purposes of this analysis, Wasaouro® was used as the source of VOM. The antimicrobial tests were conducted in MRE air-impermeable laminated packages without bread. Petri dishes containing the appropriate growth medium were inoculated with a selected spoilage organism and then sealed with various concentrations of vanillin and/or Wasaouro®. The vanillin was incorporated directly into the growth medium while the Wasaouro® was kept separate from the organism within the MRE package. The minimum inhibitory concentration of vanillin ranged from 700-1750 ppm depending on the spoilage organism evaluated with the most resistant organism being Aspergillus niger. Wasaouro® was effective at low headspace concentrations (e.g. 17 μg/L (AIT)) with the exception of Rhizopus stolonifer which is resistant to AIT even at much higher concentrations. The test data has showed that the combination of vanillin and Wasaouro® provides the necessary antimicrobial protection to prevent microbial deterioration of MRE bread during storage.

2. Evaluation of Antimicrobial Properties of Vanillin

In order to facilitate understanding of the invention and the particular antimicrobial properties of vanillin, vanillin was evaluated against the four organisms typically associated with bread without the use of Wasaouro®. Thus, a first modeling system was used to evaluate the antimicrobial properties of vanillin against (1) Penicillium notatum, (2) Rhizopus stolonifer, (3) Aspergillus niger and (4) Saccharomycopsis fibuligera. In order to evaluate antimicrobial properties of vanillin against each of these foregoing organisms, the modeling system employed four groups of Petri dishes. Each Petri dish had dimensions of 100 mm×15 mm. Each Petri dish contained a predetermined amount of potato dextrose agar (PDA agar). One of the Petri dishes in each group was used to provide control or reference data and therefore, no vanillin was added to the PDA agar in the “control dish”. For the remaining Petri dishes in each group, predetermined amounts of vanillin, in 250 PPM increments, were added to the PDA agar. Thus, vanillin, in the amounts of 500 PPM, 750 PPM, 1000 PPM, 1250 PPM and 1500 PPM were added respectively to the remaining Petri dishes. Each Petri dish in the first group was inoculated with Penicillium notatum, inoculum 10⁵ spores/ml. Each Petri dish in the first group was then uncovered and placed in its own MRE impermeable laminated package. Similarly, each Petri dish in the second group of Petri dishes was inoculated with Rhizopus stolonifer, inoculum 10⁵ spores/ml. Each Petri dish in the second group was then uncovered and then placed in its own MRE impermeable laminated package. In a similar manner, each Petri dish in the third group of Petri dishes was inoculated with Aspergillus niger, inoculum 10⁵ spores/ml. Each Petri dish in the third group was then uncovered and then placed in its own MRE impermeable laminated package. Similarly, each Petri dish in the fourth group of Petri dishes was inoculated with Saccharomycopsis fibuligera, inoculum 10⁵ spores/ml. Each Petri dish in the fourth group was then uncovered and then placed in its own MRE impermeable laminated package. All MRE packages (for all groups of Petri dishes) were then incubated at 25° C. for seven days. The determination of effectiveness of vanillin as an antimicrobial agent was based on a growth or no growth basis. Petri dishes with no growth were left out for seven days after removal from the MRE package to ensure that there was no additional growth. The results of these tests are shown in Table I.

TABLE I

| | Effective Amount Of |
|---|---|
| Organism | Vanillin |
| Saccharomycopsis fibuligera | >1000 ppm-<1250 ppm |
| Rhizopus stolonifer | >1000 ppm-<1250 ppm |
| Aspergillus niger | >1750 ppm-<2000 ppm |
| Penicillium notatum | >500 ppm-<750 ppm |

3. Evaluation of Antimicrobial Properties of VOM

Similarly, the antimicrobial properties of VOM (without vanillin) were evaluated against the four organisms shown in Table I. In order to evaluate the antimicrobial properties of VOM against each of these foregoing organisms, the modeling system employed several MRE packages. Each MRE package contained two Petri dishes. One Petri dish, 100 mm×15 mm, contained a medium and a selected organism. The second Petri dish, 60 mm×15 mm, had a Gelman cellulose filter pad. The cellulose filter pad for each 60 mm×15 mm Petri dish received a measured quantity of Wasaouro®. A stock solution of Wasaouro® powder was made and volumes of 100, 200, 400, 600, 800 and 1000 μl were added respectively to the filter pads of the 60 mm×15 mm Petri dishes for each group. One of the filters did not receive any Wasaouro® and acted as a control dish in each group. The amount of the volatile active component of Wasaouro®, allyl isothiocyanate, was determined using gas chromatography. Each Petri dish in the first group was inoculated with Penicillium notatum, inoculum 10⁵ spores/ml. Each Petri dish in the first group was then uncovered and placed in its own MRE impermeable laminated package. Similarly, each Petri dish in the second group of Petri dishes was inoculated with Rhizopus stolonifer, inoculum 10⁵ spores/ml. Each Petri dish in the second group was then uncovered and then placed in its own MRE impermeable laminated package. In a similar manner, each Petri dish in the third group of Petri dishes was inoculated with Aspergillus niger, inoculum 10⁵ spores/ml. Each Petri dish in the third group was then uncovered and then placed in its own MRE impermeable laminated package. Similarly, each Petri dish in the fourth group of Petri dishes was inoculated with Saccharomycopsis fibuligera, inoculum 10⁵ spores/ml. Each Petri dish in the fourth group was then uncovered and then placed in its own MRE impermeable laminated package. All MRE packages (for all groups of Petri dishes) were then incubated at 25° C. for seven days. The determination of effectiveness of VOM as an antimicrobial agent was based on a growth or no growth basis. Petri dishes with no growth were left out for seven days after removal from the MRE package to ensure that there was no additional growth. For each experiment, a set of control MRE packages were made with the various concentrations of Wasaouro®. These control packages were used to extrapolate the relative amounts of allyl isothiocyanate in the experimental MRE packages at time zero. The results of these tests are shown in Table II.

TABLE II

| | Effective Amount Of | |
|---|---|---|
| Organism | Allyl Isothiocyanate | |
| Saccharomycopsis fibuligera | ˜8 | ppm |
| Aspergillus niger | ˜17 | ppm |
| Penicillium notatum | ˜17 | ppm |
| Rhizopus stolonifer | >470 | ppm |

4. Evaluation of Antimicrobial Properties of Combination of Vanillin and VOM

Next, both antimicrobial agents were tested against two of the more resistant organisms, Rhizopus stolonifer and Aspergillus niger. Table III shows the growth of Aspergillus niger in the presence of vanillin and the effective concentration of allyl isothiocyanate (AIT), the active component of Wasaouro®.

TABLE III

| Vanillin | AIT Concentration (ug/L) | | | | | | |
|---|---|---|---|---|---|---|---|
| (ppm) | 0 | 55 | 150 | 145 | 465 | 420 | 905 |
| 2000 | Growth | N/G | N/G | N/G | N/G | N/G | N/G |
| | Delayed | | | | | | |
| 1750 | Growth | N/G | N/G | N/G | N/G | N/G | N/G |
| 1500 | Growth | N/G | N/G | N/G | N/G | N/G | N/G |
| 1250 | Growth | Growth | N/G | N/G | N/G | N/G | N/G |
| | | Delayed | | | | | |
| 1000 | Growth | Growth | N/G | N/G | N/G | N/G | N/G |
| | | Delayed | | | | | |
| 750 | Growth | Growth | N/G | N/G | N/G | N/G | N/G |
| | | Delayed | | | | | |
| 500 | Growth | Growth | N/A | N/G | N/G | N/G | N/G |
| 250 | Growth | Growth | N/A | N/G | N/G | N/G | N/G |
| 0 | Growth | Growth | Growth | N/G | N/G | N/G | N/G |

In Table III, “Growth” indicates that growth of Aspergillus niger was detected for the particular amount of vanillin and particular concentration of AIT, “N/G” indicates that no growth of Aspergillus niger was detected, “N/A” indicates concentrations that were not included in the test but which could show possible growth, and “Delayed” indicates that growth occurred after the Petri dishes were removed from the MRE packages. As shown in Table III, Aspergillus niger is very sensitive to AIT and growth occurred only at the lowest level of AIT tested.

Table IV shows the growth of Rhizopusus stolonifer in the presence of the combination of vanillin and Wasaouro®. The actual concentration of AIT in the headspace of the MRE package is shown in Table IV.

TABLE IV

| Vanillin | AIT Concentration (ug/L) | | | | | | |
|---|---|---|---|---|---|---|---|
| (ppm) | 0 | 55 | 150 | 145 | 465 | 420 | 905 |
| 2000 | N/G | N/G | N/G | N/G | N/G | N/G | N/G |
| 1750 | N/G | N/G | N/G | Growth | N/G | N/G | N/G |
| 1500 | N/G | N/G | N/G | N/G | N/G | N/G | N/G |
| 1250 | Growth | Growth | Growth | Growth | N/G | N/G | |
| 1000 | Growth | Growth | Growth | Growth | Growth | Growth | N/G |
| | | | | | Delayed | | |
| 750 | Growth | Growth | Growth | Growth | Growth | Growth | Growth |
| | | | | | | | Delayed |
| 500 | Growth | Growth | Growth | Growth | Growth | Growth | Growth |
| 250 | Growth | Growth | Growth | Growth | Growth | Growth | Growth |
| 0 | Growth | Growth | Growth | Growth | Growth | Growth | Growth |

As shown in Table IV, as the concentration of AIT increased, the effective amount of vanillin decreased. There was a synergistic effect with the vanillin and AIT on the organism.

Table V shows the growth of Rhizopusus stolonifer and Aspergillus niger in the presence of the combination of vanillin and Wasaouro®. As was shown in Tables III and IV, the actual concentration of AIT is shown in Table V.

TABLE V

| Vanillin | AIT Concentration (ug/L) | | | | | | |
|---|---|---|---|---|---|---|---|
| (ppm) | 0 | 55 | 150 | 145 | 465 | 420 | 905 |
| 2000 | N/G | N/G | N/G | N/G | N/G | N/G | N/G |
| 1750 | Growth | N/G | N/G | N/G | N/G | N/G | N/G |
| 1500 | Growth | Growth | S/N | S/N | N/G | N/G | N/G |
| 1250 | Growth | Growth | Growth | S/N | N/G | N/G | N/G |
| 1000 | Growth | Growth | Growth | Growth | Growth | Growth | N/G |
| 750 | Growth | Growth | Growth | Growth | Growth | Growth | Growth |
| 500 | Growth | Growth | Growth | Growth | Growth | Growth | Growth |
| 250 | Growth | Growth | Growth | Growth | Growth | Growth | Growth |
| 0 | Growth | Growth | Growth | Growth | Growth | Growth | Growth |

As shown in Table V, as the concentration of AIT increases, the effective amount of vanillin decreases to a level below that is normally needed to inhibit the growth of either organism (i.e. 1000 ppm). It was evident that there was a synergistic effect with the vanillin and AIT on the organisms.

5. Example: The Food Preservative Applied to Bread

The food preservative of the present invention was tested on bread. Specifically, the bread was formulated having a vanillin concentration of 1500 ppm and 2000 ppm. An impermeable MRE package was used for this test. A Wasaouro®Label was attached to the inside surface of the MRE package. The bread having the vanillin compound therein was then placed in the MRE package. The Wasaouro® Label had a size of 40×40 mm and was manufactured by CAREX, Inc. Once the impermeable MRE package was sealed, the Wasaouro® Label emitted the volatile VOM which then contacted the bread. The concentration of AIT in the headspace of the MRE package at time “0” was approximately 40 μg/l. A control MRE package, as described in the foregoing description, was used to determine the AIT concentration by gas chromatography. Table VI shows the effect of the combination of vanillin and VOM on the growth of mold on the MRE bread. Specifically, Table VI shows the number of positive mold cultures per-total-number of inoculations.

TABLE VI

| | | Control | | |
|---|---|---|---|---|
| | Control | (With VOM | 1500 ppm | 2000 ppm |
| | (Without VOM | and | Vanillin | Vanillin |
| Time, | and | Without | and 40 | and 40 μg/L |
| Days | Vanillin) | Vanillin) | μg/L VOM | VOM |
| 0 | 0/3 | 0/3 | 0/3 | 0/3 |
| 7 | 3/3 | 0/3 | 0/3 | 0/3 |
| 21 | 3/3 | 1/3 | 0/3 | 0/3 |
| 35 | 3/3 | 1/3 | 0/3 | 0/3 |
| 49 | 3/3 | 1/3 | 0/3 | 0/3 |
| 63 | 3/3 | 1/3 | 0/3 | 0/3 |
| 77 | 3/3 | 1/3 | 0/3 | 0/3 |
| 91 | 3/3 | 1/3 | 0/3 | 0/3 |
| 105 | 3/3 | 1/3 | 0/3 | 0/3 |

Since the VOM is volatile and its activity depends on number of factors such as the headspace area of the package, length of time in package, the type of packaging material used (i.e. permeable or impermeable) and the type of product in the package, the necessary amount of VOM will vary with these factors. Thus, the size of the Wasaouro®Labels can varied to provide a VOM concentration that is suited to the particular application. Similarly, the particular amount of vanillin depends on the particular product of interest.

Although the above tests and examples relate to the application of the preservative system of the present invention to bread (i.e. MRE bread), it is to be understood that the preservative system of the present invention can be used on other types of bread and baked products, as well as other products such as meats, cheeses, and cheese products described in the foregoing description.

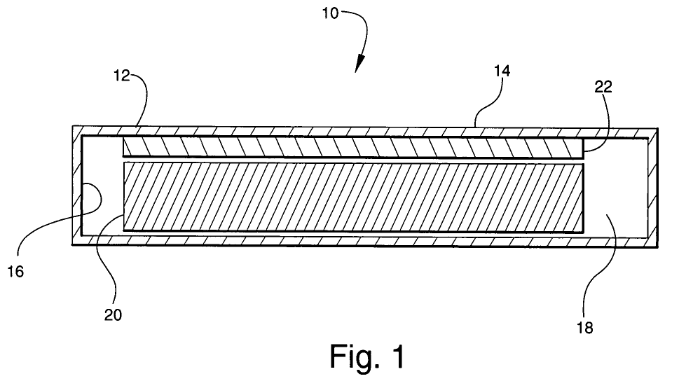

The present invention may be used with different types of containment devices used to contain food products. As used herein and as well known in the art, “containment device” means a device which is commonly used to contain products and includes packages, bags, cans, and boxes, particularly those intended for the containment of foods. Methods of incorporating preservatives within or on the containment device are well known by those of ordinary skill in the art. As will also be understood, the containment device may have the preservative system incorporated within the device or directly coated on a surface of the device. Where the preservative system is coated on a surface of a device, the preservative system is preferably coated on at least one inner surface of the containment device. Referring to FIG. 1, there is shown a cross-sectional view of packaged, preserved food product 10 in accordance with one embodiment of the invention. Packaged, preserved food product 10 comprises containment device 12. In this particular embodiment, containment device 12 comprises an impermeable package similar to the MRE packages. Containment device 12 has outer surface 14, inner surface 16 and interior 18. Bread 20, which is formulated with an effective amount of vanillin, is located in interior 18. A Wasaouro® Label 22 is attached to inner surface 16 so as to confront bread 20. When containment device 12 is sealed, the Wasaouro® Label emits the volatile VOM which permeates through the headspace of containment device 12 and contacts bread 20. It is to be understood that the Wasaouro® Label is just one example of a means for providing a constituent that has an isothiocyanate compound and that other suitable delivery systems can be used.

In an alternate embodiment, the product is formulated to contain the required amount of vanillin, and an adhesive label, similar to the Wasaouro® Label, is formed with both vanillin and VOM so as to mask the pungent odor of the VOM. Such an embodiment is useful when a relatively higher concentration of VOM is required and sensory issues are a concern in the preservation of the product.

The present invention provides several advantages and benefits:
a) antimicrobial inhibition is achieved without unpleasant taste or odors;
b) elimination of conventional in-package oxygen scavengers that are currently used in military bread MRE packets;
c) the antimicrobial agents are derived from natural sources; and
d) the food preservative system can be inexpensively implemented.

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations in changes may be made by those skilled in the art without departing from the spirit of the invention. Accordingly, the foregoing detailed description should be considered exemplary in nature and not limited to the scope and spirit of the invention as set forth in the attached claims.

1. A product comprising:
a compound comprising vanillin; and
a organic constituent comprising an isothiocynate compound.

2. The product according to claim 1 wherein the product is a food and wherein the constituent is selected from the group consisting of a Cruciferae essential oil and a natural component of a Cruciferae essential oil.

3. The product according to claim 2 wherein the Cruciferae essential oil is derived from a plant selected from the group consisting of cabbage, broccoli, Brussels sprout, turnip, mustard, watercress, radish, wasabi, and horseradish.

4. The product according to claim 3 wherein the plant is mustard.

5. The product according to claim 1 wherein the isothiocynate compound comprises allyl isothiocynate.

6. The product according to claim 1 wherein the vanillin is comprised of 4-hydroxy-3-methylbenzaldehyde.

7. A product comprising:
a first antimicrobial agent comprising vanillin; and
a second antimicrobial agent comprising volatile oil of mustard.

8. A method of preserving a food product comprising:
incorporating a compound comprising vanillin into the food product; and
exposing the food product to an organic constituent having an isothiocynate compound.

9. The method according to claim 8 wherein the constituent is selected from the group consisting of a Cruciferae essential oil and a natural component of a Cruciferae essential oil

10. The method according to claim 9 wherein the Cruciferae essential oil comprises volatile oil of mustard.

11. The method according to claim 8 wherein the vanillin is comprised of 4-hydroxy-3-methylbenzaldehyde.

12. A preserved packaged food product, comprising:
a package having a package interior and a package interior surface;
a food product positioned in the package interior and having a compound comprising vanillin; and
an organic constituent comprising an isothiocynate compound disposed on the package interior surface so as to contact the food product.

13. The preserved packaged food product according to claim 12 wherein the vanillin is comprised of 4-hydroxy-3-methylbenzaldehyde.

14. The preserved packaged food product according to claim 12 wherein the organic constituent is selected from the group consisting of a Cruciferae essential oil and a natural component of a Cruciferae essential oil.

15. The preserved packaged food product according to claim 14 wherein the Cruciferae essential oil is derived from a plant selected from the group consisting of cabbage, broccoli, Brussels sprout, turnip, mustard, watercress, radish, wasabi, and horseradish.

16. The preserved packaged food product according to claim 15 wherein the plant is mustard.

17. The preserved packaged food product according to claim 12 wherein the package is impermeable.

18. The preserved packaged food product according to claim 12 wherein said package is permeable.

19. The preserved packaged food product according to claim 12 further comprising a support attached to the package interior surface and having the organic constituent thereon.

20. The preserved packaged food product according to claim 19 wherein the support comprises an adhesive label adhered to the package interior surface.
